(19) United States
(12) Patent Application Publication
(10) Pub. No.: US 2003/0040341 A1
(43) Pub. Date: Feb. 27, 2003

(54) Multi-modal method for browsing graphical information displayed on mobile devices

(76) Inventor: Eduardo Casais, Espoo (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/237,593

(22) Filed: Sep. 10, 2002

Related U.S. Application Data
(63) Continuation of application No. PCT/FI01/00111, filed on Feb. 8, 2001.

(30) Foreign Application Priority Data
Mar. 30, 2000 (FI) 2000 0735

(51) Int. Cl. H04B 1/00

(52) U.S. Cl. 455/566; 455/563

(57) ABSTRACT

A method of browsing interactive data services with a wireless mobile device using a multi-modal technique for selecting components of an image. The method of browsing is particularly useful with mobile devices operation in accordance with Wireless Application Protocol (WAP) but is not limited thereto. A first mode of selection includes overlaying an image over a grid of cells on the display of the mobile device such as a mobile phone (FIG. 2). The cells are matched to a corresponding key on the keypad of the mobile phone. The user selects the cell containing the portion of the image of interest for further browsing by pressing the appropriate key. The cell contains a pointer to, e.g. a universal resource locator (URL) on the Internet, related information for retrieval and display on the phone. A second mode of selection includes using vocal identifiers matched to specific cells on a voice recognition capable phone or network. When the user speaks a recognized identifier, it is matched to the appropriated cell which is then selected to display the desired information.

### FIELD OF INVENTION

The present invention relates generally to mobile telecommunication systems, more particularly, it relates to an improved method of browsing interactive services with mobile devices.

### BACKGROUND OF THE INVENTION

The tremendous growth of the Internet over the years demonstrates that users value the convenience of being able to access the wealth of information available online and that portion of the Internet comprising the World Wide Web (WWW). The Internet has proven to be an easy and effective way to deliver services such as banking etc. to multitudes of computer users. Accordingly, Internet content and the number of services provided thereon have increased dramatically and is projected to continue to do so for many years. As the Internet becomes increasingly prevalent throughout the world, more and more people are coming to rely on the medium as a necessary part of their daily lives. Presently, the majority of people typically access the Internet with a personal computer using a browser such as Netscape Navigator™ or Microsoft Internet Explorer™. One disadvantage with this paradigm is that the desktop user is typically physically “wired” to the Internet thereby rendering the users' experience stationary.

Another industry that is experiencing rapid growth is in the area of mobile telephony. The number of mobile users is expected to grow substantially and, by many estimates will, if not already, outnumber the users of the traditional Internet. The large numbers of current and projected mobile subscribers has created a desire to bring the benefits of the Internet to the mobile world. Such benefits include being able to access the content now readily available on the Internet in addition to the ability to access a multitude of services available such as e.g. banking, placing stock trades, making airline reservations, and shopping etc. A further impetus arrives in the fact that adding to the attraction of providing such services is not lost on the mobile operators since significant potential revenues may be gained from the introduction of a whole host of new value-added services.

Operating in a wireless environment poses a number of constraints when bringing services to mobile subscribers as compared to the desktop experience. By way of example, mobile devices typically operate in low-bandwidth environments where there are typically limited amounts of spectral resources available for data transmission. It should be noted that the term mobile devices referred to herein may include such portable devices such as e.g. mobile phones, handheld devices such as personal digital assistants (PDAs), and communicator devices such as the Nokia 9110 etc. The low-bandwidth constraint renders traditional Internet browsing to be far too data intensive to be suitable for use with mobile phones for example. Further limitations include the relatively small display incorporated on mobile phones to facilitate improved portability and the relatively limited processing power and memory included for use in many mobile devices. The small display size, such as on mobile phones, limits the user experience when viewing, for example, web pages that are optimized for full-size desktop displays. Another limitation is the limited input facilities on mobile phones which typically lack the input devices of desktop computers such as a full-size keyboard and a pointing device such as a mouse.

One solution that has been proposed to link the Internet for seamless viewing and use with mobile phones is Wireless Application Protocol (WAP). WAP is an open standard for mobile phones that is similar in operation to the well-known Internet technology which is optimized to meet the constraints of the wireless environment. This is achieved, among other things, by using binary data transmission to optimize for long latency and low bandwidth in the form of wireless markup language (WML) and WML script. WML and WML script are optimized for use in hand-held mobile terminals for producing and viewing WAP content and are analogous to the hypertext markup language (HTML) and HTML script used for producing and displaying content on the WWW.

FIG. 1a shows the basic architecture of a typical WAP service provisioning model which allows content to be hosted on WWW origin servers or WAP servers and available for wireless retrieval. By way of example, a WAP compliant phone 10 containing a relatively simple built-in micro-browser is able to access the Internet via a WAP gateway 12 installed in a mobile phone network, for example. To access content from the WWW, a WAP client 10 may make a WML request 14 to the WAP gateway 12 by specifying an uniform resource locator (URL) via transmission 16 on an Internet origin server 18. A URL uniquely identifies a resource, e.g., a document on an Internet server that can be retrieved by standard Internet protocols. The WAP gateway 12 then retrieves the content from the server 18 via transmission 20 that is preferably prepared in WML format, which is optimized for use with WAP phones. If the content is only available in HTML format, the WAP gateway 12 may attempt to translate it into WML, which is then sent on to the WAP client 10 via wireless transmission 22 in such way that it is independent of the mobile operating standard.

The content received by the WAP phone is relatively flexible in that it may be viewed in accordance with the capabilities of the phone i.e. phones ranging from a two-line text display to more advanced displays with graphics capabilities. The presentation of information sent to the phone is performed by a system using decks and cards. As known by those skilled in the art, a deck is used metaphorically to represent a service which the user accesses. The service is further made up of plurality of cards that represent units for displaying information and for interaction. This approach was designed to ensure that a suitable amount of information is presented to the user in an orderly fashion and to simplify navigation.

At present, suitably formatted graphical content (also referred to herein as bitmaps or images) can be viewed on phones configured to display such content. In the initial WAP protocol, links associated with a particular bitmap are typically followed by selecting a text-based link on a page appearing after the bitmap. In the Internet paradigm, bitmaps are commonly used to represent structured information that enable one to click on a portion of an image having an associated virtual link pointing to further information. The idea of “clickable” bitmaps has been utilized extensively in HTML and provides for a browsing experience that is intuitive and convenient. For example, an image of a continent may contain a plurality of countries whereby clicking on (selecting) a particular country would allow you to retrieve additional information associated with that country. In selecting, the comparison between the position of the cursor of a pointing device on the screen (for example the mouse, as selected by the user) and the coordinates of the graphical objects in the clickable bitmap (for example the polygons corresponding to countries, as specified by the application) determines which virtual link is selected and followed. However, a similar graphics-based selecting technique does not exist in mobile phones today.

It seems natural to extend the technique of clickable bitmaps to the mobile environment when browsing the Internet. This would lead to the desirable situation where the mobile browsing experience would more closely compare with that on a computer which most people are already familiar. However there are several factors that present difficulties for the direct implementation on mobile devices. The most obvious is the lack of a pointing device such as a mouse since, in order to promote ease of use and portability, peripherals are typically discouraged. In addition, accurately positioning a pointer on the screen can be difficult while standing or walking especially when using a device with a small screen such as a phone. Moreover, the addition of peripherals would make services dependent on the kind of mobile device i.e. use would be limited to those having the required peripheral. Another factor is that the mobile devices would require additional software, processing power and memory which may increase the cost thereby hindering wide-spread acceptance.

In view of the foregoing, it would be desirable to provide a method of selecting segments of bitmap images which can lead to the retrieval of further information displayed on mobile devices. Moreover, it would be advantageous to implement a technique that does not require the need for complicated user interface mechanisms or special pointing or scrolling devices. It would be further advantageous if the implementation of such capability does not significantly increase the cost of the device.

### SUMMARY OF THE INVENTION

Briefly described and in accordance with embodiments thereof, the invention discloses a method of providing the user a technique in which to “click” through images displayed on a wireless mobile device such as a mobile phone during an online interactive session. The method includes designating a grid of contiguous cells to underlie a bitmap image presented on the display of the mobile phone. A portion of the displayed image is systematically contained in each cell such that combination of cells contains the entire image. The application developer may create uniform or non-uniform cells that are suitable for containing certain features of a complex image so they can be easily and intuitively selected. The individual cells are associated with virtual links pointing to further information relating to that portion of the image it contains. In an embodiment comprising a first mode of selection, the cells are mapped to a corresponding key on the mobile phone keypad. The selection of a cell by the user is performed by pressing the corresponding key of the associated cell to initiate a request to retrieve the desired information from e.g. a server on the Internet.

In an embodiment comprising a second mode of selection, the cells are mapped to vocal identifiers for use with speech recognition capable mobile phones and/or networks. The vocal identifiers spoken by the user are interpreted by a speech recognition system and matched to the corresponding cell containing the portion of the image of interest. When a cell has been positively identified it is selected such that related information is displayed on the mobile phone via a virtual link associated with the cell that points to the appropriate server location where the information is stored.

In a further embodiment, the user is able to perform selection using the first mode (via the keypad) or second mode (via vocal identifiers) during the same session whereby the phone is appropriately configured to react to either selection mechanism from the user at any time. According to a first aspect of the invention there is provided a method of browsing a data service with a wireless mobile device having a display capable of displaying images, the method comprising the steps of:

displaying an image on said display;

superimposing said image over a grid of selectable cells;

associating each of the cells with a specific action;

selecting said cell in response to performing the specific action, wherein the specific action comprises one of

pressing an appropriate key on a keypad of the mobile device to select a particular cell and

speaking a vocal identifier into the mobile device to select a particular cell; and retrieving information for display associated with the selected cell

According to a second aspect of the invention there is provided a wireless mobile device for browsing data content as part of a data service, the wireless mobile device comprising:

a micro-browser for browsing and retrieving data content of the data service; and

a display for displaying an image retrieved by the micro-browser; and

the wireless mobile device being configured to select a portion of an image displayed by any one of pressing a key associated with said portion and speaking a vocal identifier associated with said portion; and

the micro-browser being configured to retrieve data content relating to the selected portion of the image for presentation on said display.

### BRIEF DESCRIPTION OF THE DRAWINGS

The invention, together with further objects and advantages thereof, may best be understood by reference to the following description taken in conjunction with the accompanying drawings in which:

FIG. 1a is an illustration of a typical WAP service model;

FIG. 1b shows a simplified depiction of a typical mobile phone having a display partitioned by a uniform cell arrangement;

FIG. 2 shows a bitmap image on a mobile phone display partitioned with a non-uniform cell arrangement; and

FIG. 3 shows a bitmap image on a mobile phone display partitioned with irregularly shaped cells.

### DETAILED DESCRIPTION OF THE PREFERRED EMBODIMENTS

As discussed in the preceding sections, Internet based services designed to be accessed by mobile devices can often benefit from clickable bitmaps. This especially becomes the case as more mobile devices start appearing on the market with advanced graphics capabilities. The advent of Wireless Application Protocol (WAP) and multimedia messaging over short message service (SMS) e.g. in devices operating in accordance with Global System for Mobile Communication (GSM), further highlights the need for a relatively simple technique for browsing by selecting portions of images displayed on mobile devices.

In accordance with an embodiment of the invention, a first mode of selection comprises a method wherein the user physically interacts with the phone. By way of example, specific actions performed by a user are interpreted by a browser, such as that used in Wireless Application Protocol (WAP), which are mapped to portions of a displayed image on a mobile phone for use at the application level while browsing.

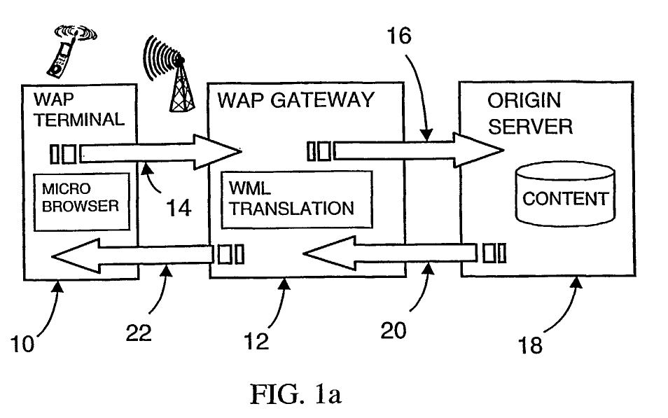

Referring to FIG. 1b, a simplified depiction of a typical mobile phone is shown having a relatively small screen for displaying images or text and a standard keypad for entering digits zero through nine into the phone. The display screens on many mobile phones often take on an approximately square or rectangular shape. Likewise, the keypad on most mobile phones are often laid out in a standard arrangement usually having a pattern of four rows by three columns e.g. the digit “one” in the top left comer and the digit “zero” in the bottom row. The selection of a segment of an image displayed thereon may be performed by depressing a key on the keypad. For example, an image presented in the display area 100 can be virtually segmented into a regular grid of nine equally segmented cells. The cells are arranged in a three-by-three grid wherein each of the cells are logically mapped to an associated key on keypad 10. By way of example, key 1 is mapped to the top-left cell, key 2 is mapped to the top-center cell, key 3 to the top-right cell, key 4 to the middle-left cell, key 5 to the center cell, key 6 to the middle-right cell, key 7 to the bottom-left cell, key 8 to the bottom-center cell, and key 9 to the bottom-right cell.

An image is overlaid on top of the cells over the entire surface area of the display 100. A portion of the image that the user may be interested in selecting lies within a unique cell and can be selected when the user presses a corresponding key. This action initiates the retrieval of information by following a previously stored virtual link associated with the selected cell. The configuration of the cells may be adapted to the geometric nature of the images displayed wherein, for example, individual images may present themselves to be more suitably partitioned by non-uniform cells. Bitmaps of images containing unusual features or irregular objects can be selected in logically constructed cells that are fitting for the particular image being displayed. The cells are generally constructed by the application developer so that a desired feature can be intuitively selected by the user. It is up to the application developers to partition their images in a meaningful and preferably in as a non-ambiguous manner as possible.

The elaboration of the image, the grid of cells, and the definition of the selectable links is carried out with image processing tools and text editors—ideally, as known by those skilled in the art, with a suitable authoring tool for the complete development of interactive data browsing applications. Among the necessary steps to construct the application, the original image is overlaid with the lines that mark the border between the cells. The application developer may draw the lines on the picture with an image editor. The resulting bitmap is possibly converted to a format appropriate for the terminal and then saved. In another step, the application developer uses an application editor, a text editor or any other suitable tool to define the structure of the document, to introduce a reference to the image, and to define which link to access upon selecting each cell. Some authoring tools may provide facilities to generate a skeleton for data browsing applications automatically, based on pre-defined application templates. The application developer has only to fill in specific information such as the exact URL corresponding to each link, or the name of the file where the image is stored. Once the application is ready, it can be published on a server and made available to the end-users.

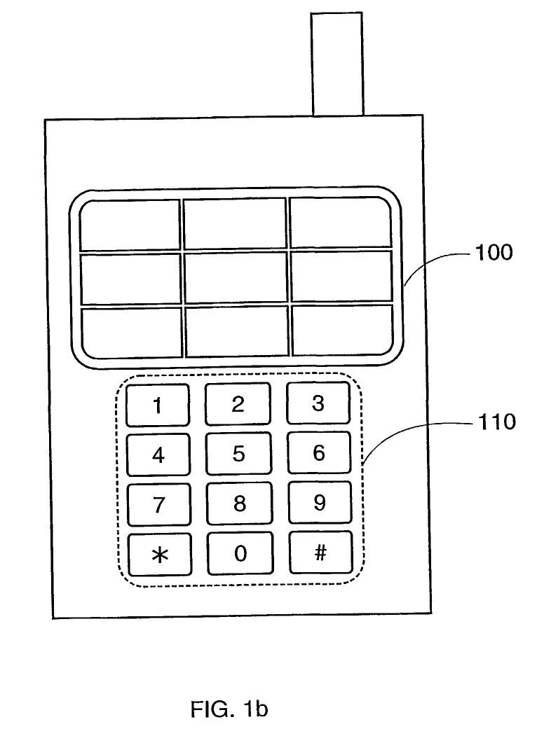

FIG. 2 illustrates a situation where non-uniform cells may be used for partitioning an image presented on a mobile phone display 200. The image includes a picture of two irregular shaped lakes 210 and 215 shown together with surrounding geographical landmass and superimposed on an underlying non-uniform grid of four cells. When the user wants to browse further information related to the top lake 210, for example, either key two or key three on the keypad can be used to select the associated cell. In this case both keys two and three can be mapped to this area in the top right corner of the display. It should be noted that the areas need not follow the strict boundaries of an underlying rectangular grid given that there is no ambiguity in the assignment of the cells to the areas. Generally speaking, the assignment of cells to areas can be quite flexible. As an example, in a situation on a display containing cells A, B, and C and areas X, Y, and, Z, cell C can be unambiguously assigned to area X if, for example, the center of cell C does not lie on a boundary between area X and another area such as Y or Z and if more than 50% of cell C lies in area X. A further requirement is such that each area has at least one cell unambiguously associated with it so it each area can be selected. Other constraints can be elaborated depending on the topology of images so that their mapping to the underlying cell grid remains intuitive.

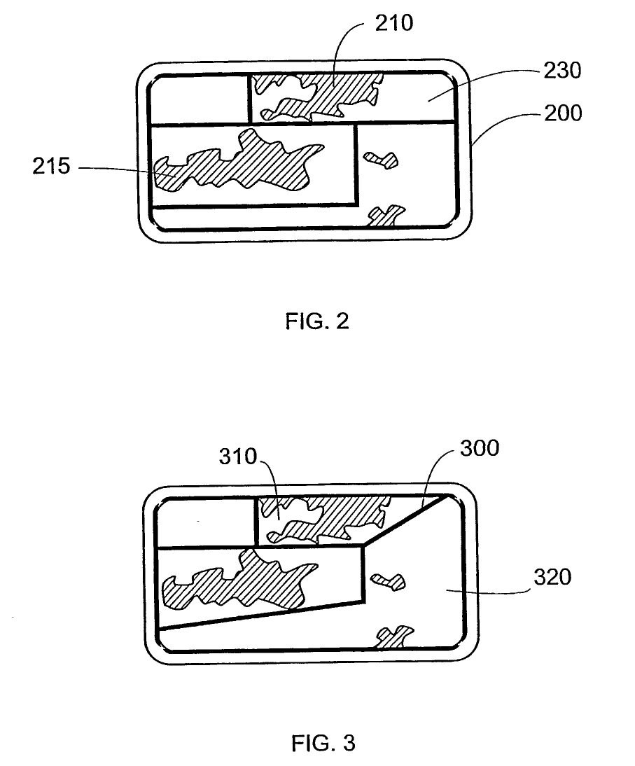

FIG. 3 shows an example where the image in FIG. 2 is partitioned in a slightly different manner such that the area in the top-right area of the display cannot be unambiguously resolved. This is because its center lies on boundary 300 between two adjoining areas 310 and 320. Thus pressing key three to select this area would not result in a valid selection by an application and will likely return a visible warning such as “ambiguous selection” on the display or an audible error tone. Another approach would be to permit ambiguity, notice for example area 310 could be unambiguously selected via key number 2, whereas area 320 could be unambiguously selected via keys 6, 7, 8 or 9 if the application developer so chooses. One way to resolve the ambiguity problem is to show explicitly the mapping associations to the user. By way of example, this can be achieved by displaying a small numeral in each cell indicating the key the user must press in order for that cell to be selected. This would eliminate the uncertainty arising from relying on user intuition for area association when applied to images partitioned in irregular ways.

As a practical matter the boundaries of the cells need not be restricted to continuous straight lines. They may consist of curves or multiple segmented lines which can be suitably applied to uniquely conform to a particular image. Furthermore, the boundaries may be represented in such a way that it makes it easier for the user to discern. For example on color displays, a boundary may be represented by a color that stands out from the original image or the potential object such as lake 210 for example. On black and white displays this can be accomplished by inverting the pixels of the boundary versus the surrounding portions of the image i.e. a white boundary on black parts of the image or black boundary on white parts of the image.

In another embodiment of the invention, a second mode of selection comprises a method of vocal selection wherein the user simply speaks into a voice enabled phone employing speech recognition technology to select a desired cell. As known to those skilled in the art, speech recognition technology has been known in the art of computer software for some time but implementation of the technology in mobile phones have only recently begun to appear. Mobile phones that employ limited vocabulary speech recognition and the underlying technology behind it are already on the market in such phones as the Nokia 8210 and Nokia 8850. These phones employ the technology in connection with voice dialing whereby users can, for example, say the name of the person they want to call and the phone recognizes it and automatically dials the correct number. Generally, the implementation of speech recognition in mobile systems typically fall into the categories of localized systems and distributed systems, where in localized systems, speech processing is performed in the phone and in distributed systems, processing tasks are performed at the mobile network level.

When using vocal selection, the employment of the speech recognition technology in connection with cell selection can include the use of a limited vocabulary to identify the desired cells successfully. By way of example, with regard to the uniform cell grid of FIG. 1b, the cells can be mapped to vocal identifiers such as “top-left” which maps to the top-left cell, “top-center” maps to the top-center cell, “top-right” maps the top-right cell, “middle-left” to the middle-left cell, “center” to the center cell, “middle-right” to the middle-right cell, and “bottom-left”, “bottom-center”, and “bottom-right” to their respective cells of the grid. Similarly, the application developer may tailor the vocal identifiers such that they are fitting for the image and intuitive for the user to figure out. In using a limited vocabulary, the limited number of terms do not require an undue amount storage or processing power thereby being economical and well suited for incorporation into mobile phones. In addition, using a limited vocabulary makes it easier to implement speaker-independent speech recognition functions where it is not necessary to train the speech recognizer to adapt to a particular individual. It should be noted that the invention may be used with unlimited vocabulary speech recognition systems which are typically more complex but have the advantage of being more flexible.

The vocabulary used in the present invention may be supplemented by descriptive terms to make it more clear or intuitive for the user such as e.g. “north”, “east”, “south”, “west”, “north-east”, “north-west”, “south-east”, “south-west” etc. Other terms may include “fore”, “aft”, “starboard”, and “port”, for example. Where there may be ambiguity due to an irregularly shaped image, a word (or abbreviation of the word) may be displayed in the cell prompting the user with the correct phrase in order to select it. A another possibility would be to allow use of a combination of modes wherein numbers are displayed in the cells and the user has the choice of being able to select the cell by using the keypad or speaking the number into the phone. In using vocal selection, one can retrieve information via the virtual links associated with an image without physically manipulating the phone. This can be useful in situations where hands-free operations are necessary, such as when driving a car for example.

Those skilled in the art will appreciate the fact that speech recognition selection techniques can be implemented at the network level for use with phones lacking voice-enabled capability. In this case, a non-voice enabled mobile phone may, for example, have speech from the user transmitted to dedicated speech recognition server connected to the network. By way of example, the speech recognition server may send the text string corresponding to the recognized speech utterance back to the phone, where the selection is processed further in the normal way by mapping the string to a particular cell. Alternatively, the text string may be sent to an application server that will interpret it, handle the selection, retrieve the content and then send it back to the phone. In any the case, either the transmission of voice and data takes place over a bearer that allows such mixed mode communications, such as could happen in a packet-data system where voice is transmitted via mechanisms generally known as “voice_over_IP” (Internet Protocol), or two different communication channels must be established, one for voice and the other for data. As an example, in GSM the image data together with data requests sent to and from e.g. the WAP server or a multimedia messaging server may be transmitted to and from the phone via the SMS bearer, while speech is transmitted over the normal voice channel. This approach requires the coordination of the transmission and reception of data and voice over two different communication bearers. If the speech recognition takes place in the mobile phone itself, then the text string corresponding to the recognized speech utterance is constructed in the phone without the need for communication with a speech recognition server over a wireless network, and is passed on to the browser directly for further processing of the selection. A more thorough discussion of speech recognition and audio control used in connection with mobile devices is given in European Patent publication EP 0959401, entitled: “Audio Control Method and Audio Controlled Device”, published on Nov. 24, 1999.

In a further embodiment, the invention allows for the use either mode of selection during the same session i.e. both key based and vocal selection can be employed concurrently since both methods rely upon the same cell-based selection mechanism. This possibility may become attractive when, for instance, the environment becomes suddenly noisy, as could occur when crossing a corridor from one room to another or when loudspeaker announcements are made in a waiting hall of an airport for example, so that using vocal selection becomes difficult or unreliable. When users are not confident in the operation of the speech recognizer, it is often reassuring for the user to know they can rely upon using the keypad in order to select cells unambiguously. In a case of mixed keypad and vocal selection, the browser in the phone may receive information about the selection of a cell from either the keypad input-output module which is activated when the user presses a key on the keypad, or the speech recognition engine which is activated by speech utterances, or a server on a network which is activated when receiving speech utterances sent by the phone for recognition and processing. In the latter situation, the coordination of the voice and data paths on the server may become quite complex because of the latencies involved and the necessity to keep track of the state of a session with respect to the phone, the communication bearers, the speech recognition server, the application server, and the possible gateways.

There are several ways to specify how links are activated upon a vocal or keypad selection. We illustrate possible approaches with respect to the WAP Markup Language (WML).

In a first approach, the entire image (with the indication of the cell borders) is split into at most nine bitmaps, which are placed consecutively on at most three lines in the document being browsed. Each bitmap corresponds to a cell. Generally, all bitmaps in one line should at least have the same height, but need not have the same width. However, all lines of bitmaps must have the same width, although all lines need not have the same height. Splitting the entire image into different bitmaps can be done with a proper image processing tool when developing the application. Associated with each bitmap is a WML “anchor”, with an “access key” that serves to select the link corresponding to an image. The application document for the example in FIG. 3 may look as follows:

<a accesskey=“1”href=“infoNW.wml”><img alt=“north west”src=“NW.wbmp”/></a>

<a accesskey=“2”href=“infoNNE.wml”><img alt=“north east”src=“NNE.wbmp”/></a>

<a accesskey=“3”href=“invalidselection.wml”></a>

</br>

<a accesskey=“4”href=“infoW.wml”><img alt=“west”src=37 W.wbmp”/></a>

Upon entering the WML card where they are contained, all images are displayed. Pressing key number 1 on the keypad results in the selection of the link corresponding to this “access key”, which instructs the browser to fetch the information contained in infoNW.wml and display it on the terminal. The browser follows a similar behaviour for the other keys, except those that correspond to ambiguous or invalid selections (such as key “3”).

With vocal selection, the speech recognition software in the terminal maps the speech utterance to a number and then communicates it, via an appropriate software interface, to the browser. The behavior of the browser is then the same as if the keypad had been pressed when a vocal selection has been performed.

An alternative approach consists of placing the anchors and their associated bitmaps in a table of at most three columns by at most three rows. In principle, tables typically provide more facilities to enforce the proper layout and alignment of their constitutive elements; however, this method may also require all bitmaps to have the same width. An example follows:

<table title=“map of the region”columns=“3”align=“LLL”>

<tr>

<td><a accesskey-“1”href=37 infoNW.wml”><img alt=“north west”

src=“NW.wbmp”/></a></td>

<td><a accesskey=“2”href=“infoNNE.wml”><img alt-“north east”

src=“NNE.wbmp”/></a></td>

<td><a accesskey=“3”href=“invalidselection.wml></a></td>

</Ir>

<tr>

<td><a accesskey=“4”href=“infoW.wml”><img alt=“west”src=“W.wbmp”/></a></td>

Vocal selection proceeds as explained in the earlier example.

In the case where the browser in the terminal is able to deal with anchors that have no associated images or text, it is possible to keep the image in one piece and define invisible anchors that are selected via the “access keys”, an example follows:

<img title=“region map”alt=“map of the region”src=“region.wbmp”/>

<a accesskey=“1”href=“infoNW.wml></a>

<a accesskey=“2”href=“infoNNE.wml”></a>

<a accesskey=“3”href=“invalidselection.wml”></a>

The advantages of this approach are the avoidance of image splitting and the simpler definition of links.

A further possibility to define how links are activated is to map the pressing of keys or the recognition of speech utterances to specific events, and associate these events to an automatic selection of links. An advantage is that the overall image to be browsed need not be split into several bitmaps. The WML document may then take a form such as:

<card>

<onevent type=“1”><go href=“infoNW.wml”/></onevent>

<onevent type=“top left”><go href=37 infoNW.wml”/></onevent><img title=“region map”alt=“map of the region”src=“region.wbmp”/>

</card>Pressing keys “1” to “9” results in the corresponding event being raised in the browser.

Recognition of speech utterances such as “top left” results in the speech engine raising a corresponding event in the browser, via an appropriate software interface.

Naturally, the suitability of the aforementioned techniques depends on how the terminal formats and lays out the information being browsed, or on the possibility to extend the WML language with new event types. It should be noted that the approaches described are illustrative and do not exclude other implementations. The significance lies in the fact that they rely upon existing fundamental mechanisms of WML to define links (or “anchors”), activate them, retrieve the associated document based on the user selection, and display it. Similar approaches are possible with other markup languages that rely upon substantially equivalent mechanisms, such as HTML.

The present invention contemplates a multi-modal technique for use with image selection which is particularly useful in navigating Internet based interactive services. The techniques described herein are especially suitable for use with mobile devices without the need for complicated user interface mechanisms or special pointing device accessories or peripherals. Although the invention has been described in some respects with reference to specified preferred embodiments thereof, variations and modifications will become apparent to those skilled in the art. In particular, the invention is not restricted to mobile phones but is applicable to a wide range of devices that are capable of accessing Internet-based services such as e.g. PDAs, personal and notebook computers, communicator devices etc. Furthermore, the invention may be applicable to other types of browsing sessions than those operating in accordance with WAP. It is therefore the intention that the following claims not be given a restrictive interpretation but should be viewed to encompass variations and modifications that are derived from the inventive subject matter disclosed.

1. A method of browsing a data service with a wireless mobile device having a display capable of displaying images, the method comprising the steps of:
displaying an image on said display;
superimposing said image over a grid of selectable cells;
associating each of the cells with a specific action;
selecting said cell in response to performing the specific action, wherein the specific action comprises one of
pressing an appropriate key on a keypad of the mobile device to select a particular cell and
speaking a vocal identifier into the mobile device to select a particular cell; and
retrieving information for display associated with the selected cell.

2. A method according to claim 1 wherein said grid forms a uniform grid of cells.

3. A method according to claim 1 wherein said grid forms a non-uniform grid of cells suitably conforming to particular features of the image.

4. A method according to claim 1 wherein said data service locates on a server which the wireless mobile device accesses over a wireless connection.

5. A method according to claim I wherein said information associated with the selected cell is retrieved by following a previously stored virtual link.

6. A method according to claim 1 wherein the specific action of cell selection using the keypad or vocal identifiers occurs during the same browsing session as having retrieved said image.

7. A method according to claim 2 wherein the uniform grid comprises a three-by-three grid of cells, and wherein the cells are suitably mapped to keys one through nine of the mobile device.

8. A wireless mobile device for browsing data content as part of a data service, the wireless mobile device comprising:
a micro-browser for browsing and retrieving data content of the data service; and
a display for displaying an image retrieved by the micro-browser; and
the wireless mobile device being configured to select a portion of an image displayed by any one of pressing a key associated with said portion and speaking a vocal identifier associated with said portion; and
the micro-browser being configured to retrieve data content relating to the selected portion of the image for presentation on said display.

9. A mobile device according to claim 8 wherein said micro-browser operates in accordance with Wireless Application Protocol (WAP).

10. A mobile device according to claim 8 wherein said device comprises a speech recognition system to select said portion of the image by speaking a vocal identifier.

11. A mobile device according to claim 10 wherein said wireless mobile device permits the use of keypad selection and speaking a vocal identifier during the same browsing session as having retrieved said image.

12. A mobile device according to claim 9 wherein the data content is a page formatted in any one of wireless markup language (WML) and wireless bitmap format (WBMP).

13. A mobile device according to claim 12 wherein the data content is stored on and retrieved from a WAP server for presentation on the display.

14. A mobile device according to claim 8 wherein said image locates on a server which the wireless mobile device accesses over a wireless connection.

15. A mobile device according to claim 8 wherein said micro-browser is configured to retrieve the data content relating to the selected portion of the image by following a previously stored virtual link.
